(19) United States
(12) Patent Application Publication
(10) Pub. No.: US 2006/0238173 A1
(43) Pub. Date: Oct. 26, 2006

(54) Power supply system and device testing apparatus having the same

(76) Inventors: Junya Taniguchi, Tokyo (JP); Akifumi Kaneko, Kanagawa (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/372,228

(22) Filed: Mar. 10, 2006

(30) Foreign Application Priority Data
Mar. 11, 2005 (JP) 2005-69127

(51) Int. Cl. G05F 1/70

(52) U.S. Cl. 323/211

(57) ABSTRACT

A power supply system has a judging circuit for judging occurrence of an overload condition by monitoring a power supply voltage applied to a device under test. The judging circuit detects, as reverse insertion of the device under test into a socket, occurrence of overload immediately after application of the power supply voltage to the device under test. Application of the power supply voltage to the device under test is shut down in a short time approximately equal to a rise time of the power supply voltage.

This application claims priority to prior Japanese patent application JP 2005-69127, the disclosure of which is incorporated herein by reference.

### BACKGROUND OF THE INVENTION

This invention relates to a power supply system and, in particular, to a power supply system capable of shutting down power supply upon detection of overload and a device testing apparatus having the power supply system.

A device testing apparatus for a semiconductor device has a socket for electrical connection to a device under test (DUT). A test is carried out by inserting the DUT into the socket and applying a power supply voltage and a test signal from the device testing apparatus to the DUT. After completion of the test, an exchanging operation of removing the DUT from the socket and inserting a next DUT into the socket is carried out. Since a large number of DUTs are tested, such exchanging operation is frequently and repeatedly carried out. In this situation, reverse insertion of improperly or reversely inserting the DUT into the socket tends to occur by human error.

In order to prevent a damage of the device testing apparatus and a breakage of the DUT as a result of the reverse insertion, a fuse to be melt down by overcurrent and a reversible fuse have often been used. However, in known techniques using these fuses, several milliseconds to several seconds are required until power supply is shut down. Accordingly, in case of a BGA (Ball Grid Array) package often used in recent DUTs, there is a problem that a solder ball is melt during the above-mentioned time period and the device testing apparatus and the DUT will be damaged. Therefore, it is desired to develop a power supply system capable of detecting the reverse insertion in a shorter time to reliably and safely shut down the power supply.

As a conventional power supply system of the type, Japanese Unexamined Patent Application Publication (JP-A) No. H01-264695 discloses a PROM (Programmable Read Only Memory) writer having a protection function against reverse insertion. In the PROM writer, when a PROM is inserted into a socket, the PROM is first applied with a low voltage lower than a predetermined power supply voltage. The PROM writer compares an electric current flowing through the PROM at the low power supply voltage and a reference electric current for detection to judge whether or not the PROM is normally inserted into the socket. If the PROM is inserted reversely, the PROM writer generates an alarm to warn an operator. Thus, the PROM is prevented from being broken due to the reverse insertion.

However, in order to detect the reverse insertion of the device (PROM), the PROM writer disclosed in the above-mentioned publication requires an additional test of applying a low voltage to detect occurrence of the reverse insertion. Therefore, the number of test items is increased so that a test time is lengthened. Under the circumstances, it is desired to develop a method of detecting the reverse insertion at a high speed as a part of an ordinary evaluation test without increasing the test time.

### SUMMARY OF THE INVENTION

It is an object of this invention to provide a power supply system capable of detecting reverse insertion of a device at a high speed without increasing a test time in order to detect the reverse insertion and of reliably and safely shutting down power supply upon detection of the reverse insertion.

It is another object of this invention to provide a device testing apparatus having the above-mentioned power supply system.

According to a first aspect of this invention, a power supply method is provided. In the power supply method, when a power supply voltage is applied to a device under test, the power supply voltage is continuously monitored from a rise time instant of the power supply voltage at the start of application of the power supply voltage. In this case, application of the power supply voltage is shut down if the power supply voltage does not reach a set value in a preselected time period from the start of application of the power supply voltage.

According to a second aspect of this invention, a power supply system is provided. The power supply system comprises a power supply for applying a power supply voltage to at least one device under test, a timer for counting up a preselected time period from the start of application of the power supply voltage, and an overload detecting circuit for detecting whether or not the power supply voltage applied to the device under test is equal to or higher than a set value. Application of the power supply voltage is shut down if the overload detecting circuit detects, after lapse of the preselected time period, that the power supply voltage applied to the device under test is lower than the set value.

It is preferable that the power supply system further comprises a logical circuit and a remote on/off circuit. In this case, the logical circuit executes a logical operation between an output of the overload detecting circuit and an output of the timer and produces a logical operation result as an output control signal. The remote on/off circuit controls application of the power supply voltage in response to the output control signal.

The power supply system may be adapted to apply a power supply voltage to a plurality of devices under test. In this case, the power supply system further comprises a counter switch between the devices under test and the power supply. The counter switch sequentially switches connection between the devices under test and the power supply.

According to a third aspect of this invention, a device testing apparatus is provided having a power supply system. The power supply system comprises a socket for receiving a device under test to be inserted therein, a power supply for applying a power supply voltage to the device under test, and a judging circuit for judging whether or not the power supply voltage applied to the device under test is equal to or higher than a set value. The judging circuit stops application of the power supply voltage to the device under test if the power supply voltage applied to the device under test is lower than the set value.

In the device testing apparatus, the judging circuit comprises a timer for counting a preselected time period from the start of application of the power supply voltage to the device under test. The judging circuit judges that the device under test is reversely inserted into the socket and stops application of the power supply voltage to the device under test if the power supply voltage applied to the device under test does not reach the set value within the preselected time period.

In the device testing apparatus, it is preferable that the power supply comprises a remote on/off circuit for controlling application of the power supply voltage to the device under test. The remote on/off circuit stops application of the power supply voltage to the device under test in response to an output control signal from the judging circuit.

In the device testing apparatus, the power supply system may comprise a plurality of sockets. In this case, the power supply system further comprises a counter switch between the sockets and the power supply. The counter switch sequentially switching connection between the sockets and the power supply.

### BRIEF DESCRIPTION OF THE DRAWING

FIG. 1 is a block diagram showing a structure of a power supply system according to a first embodiment of this invention;

FIG. 2 is a view for describing a logical operation of the power supply system illustrated in FIG. 1 during a normal operation;

FIG. 3 is a view for describing a logical operation of the power supply system illustrated in FIG. 1 upon occurrence of reverse insertion; and

FIG. 4 is a block diagram showing a structure of a power supply system according to a second embodiment of this invention.

### DESCRIPTION OF THE PREFERRED EMBODIMENTS

### First Embodiment

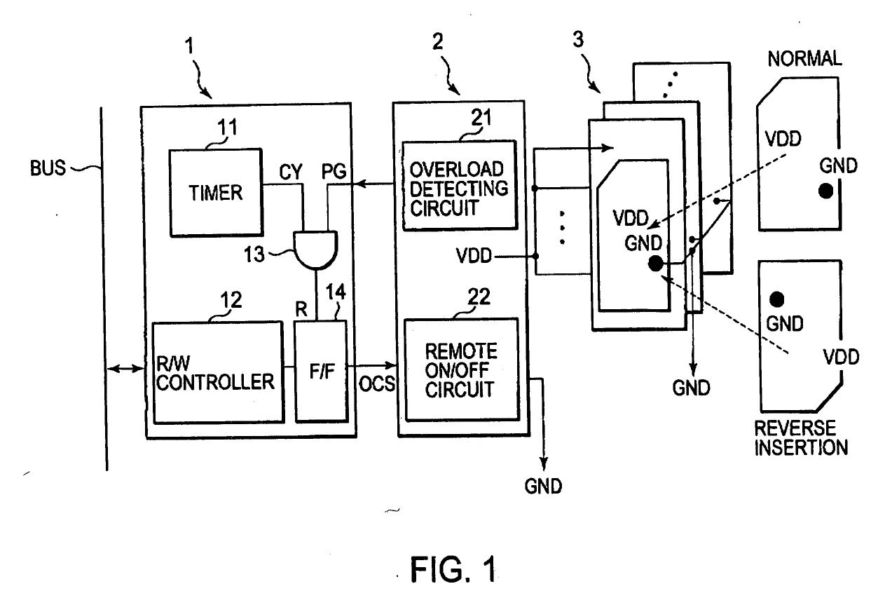

Referring to FIGS. 1 through 3, a power supply system according to a first embodiment of this invention will be described.

In an example illustrated in FIG. 1, the power supply system is used in a device testing apparatus. The power supply system comprises a judging circuit 1 connected to a system bus BUS for signal transmission to and from a CPU (not shown) for controlling the device testing apparatus, a DUT power supply 2, and a plurality of DUT sockets 3. The DUT power supply 2 applies a power supply voltage VDD to a DUT inserted into each of the DUT sockets 3. The judging circuit 1 comprises a timer 11, a R/W (Read/Write) controller 12, an AND circuit 13, and a F/F (Flip/Flop) circuit 14. The timer 11 starts a counting operation in response to a write instruction from the system bus BUS, carries out the counting operation for a preselected time period, and produces a count-up signal CY. The preselected time period is determined with reference to a rising rate of the power supply voltage VDD applied to the DUT and a required time for asserting a PG (Power Good) signal PG which will later be described. For example, in case where about 100 μsec is required as the required time after the DUT power supply 2 is turned on and before the PG signal PG is asserted, the timer 11 is given 200 μsec as the preselected time period and produces the count-up signal CY after lapse of 200 μsec.

The R/W controller 12 is adapted to control on and off of the DUT power supply 2 in response to the write instruction from the system bus BUS and to inform the system bus BUS of a state of the DUT power supply 2 in response to a read instruction. A signal from the R/W controller 12 is sent to the F/F circuit 14. Supplied with the count-up signal CY from the timer 11 and the PG signal PG from the DUT power supply 2, the AND circuit 13 delivers a reset signal R to the F/F circuit 14. Thus, after the count-up signal CY becomes valid or effective, a value or level of the PG signal PG is judged. Supplied with the signal from the R/W controller 12 as an input signal and the reset signal R from the AND circuit 13, the F/F circuit 14 produces an output control signal OCS and delivers the output control signal OCS to the DUT power supply 2. A combination of the AND circuit 13 and the F/F circuit 14 may be called a logical circuit.

The DUT power supply 2 comprises an overload detecting circuit 21 and a remote on/off circuit 22. The remote on/off circuit 22 is supplied with the output control signal OCS from the judging circuit 1 and controls application of the power supply voltage VDD to the DUT socket 3. The overload detecting circuit 21 monitors the power supply voltage VDD as an output voltage and detects whether or not the power supply voltage VDD has a voltage value which is equal to or higher than a set value. When the power supply voltage VDD has the voltage value which is equal to or higher than the set value, the overload detecting circuit 21 asserts the PG signal PG. For example, if the DUT is reversely inserted into the DUT socket 3 and an overload is applied to the DUT power supply 2, the power supply voltage VDD has a voltage value smaller than the set value. If the power supply voltage VDD has the voltage value smaller than the set value, the PG signal PG is put into a negated state.

The power supply system according to the first embodiment comprises the judging circuit 1 and the DUT power supply 2 and has a function of shutting down an output upon occurrence of overload during operation of the DUT power supply 2 or upon occurrence of overload by reverse insertion immediately after the DUT power supply 2 is turned on. Thus, in the power supply system, by the use of the overload detecting circuit 21 and the remote on/off circuit 22 of the DUT power supply 2, the output is shut down upon occurrence of overload during operation of the DUT power supply 2 or upon occurrence of overload by reverse insertion immediately after the DUT power supply 2 is turned on.

The judging circuit 1 detects occurrence of reverse insertion at the DUT socket 3 to shut off the output upon occurrence of overload immediately after the DUT power supply 2 is turned on. Herein, the timer 11 is given 200 μsec as the preselected time period. Therefore, even upon occurrence of the reverse insertion, the DUT is power-supplied only for a short time of about 200 μsec and is prevented from being broken. The DUT power supply 2 is turned on through the system bus BUS. Subsequently, the state of the DUT power supply 2 is read. As a consequence, if the DUT power supply 2 is in an ON state, it is judged that the DUT is normally inserted. If the DUT power supply 2 is shut down, it is judged that the DUT is reversely inserted. Since the DUT power supply 2 is shut down by hardware of the judging circuit 1, it is unnecessary to instruct shutting down of the DUT power supply 2 through the system bus BUS.

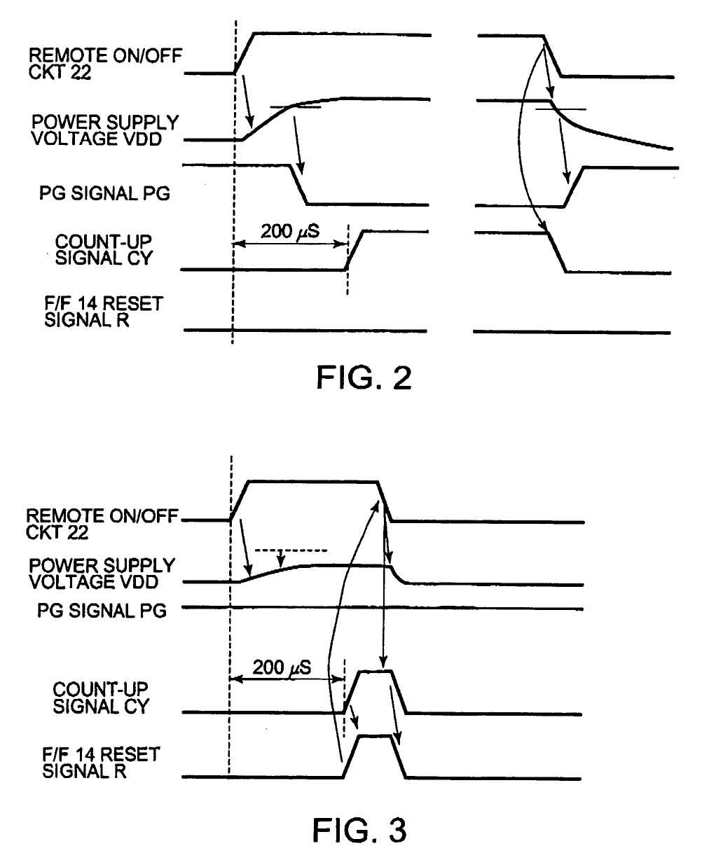

Referring to FIGS. 2 and 3, the above-mentioned operation will be described.

During a normal operation in FIG. 2, the signal from the remote on/off circuit 22 has a high level. The power supply voltage VDD is applied to the DUT and rises up. It is assumed here that the set value of the overload detecting circuit 21 is equal to 80% of the predetermined value of the power supply voltage VDD. When the voltage value of the power supply voltage VDD is equal to or higher than the set value, the DUT power supply 2 asserts the PG signal PG As a result, the PG signal PG is turned into a low level. The timer circuit 11 produces the count-up signal CY of a high level after lapse of the preselected time period of 200 μsec after the signal from the remote on/off circuit 22 is turned into a high level. Since the PG signal PG has the low level, the reset signal R of the F/F circuit 14 is kept at a low level and the power supply voltage VDD is kept applied to the DUT. When the signal from the remote on/off circuit 22 is turned into a low level, application of the power supply voltage VDD is stopped and the count-up signal CY is reset. Subsequently, since the voltage value of the power supply voltage VDD becomes smaller than the set value, the PG signal PG is turned into a high level. As a consequence, the reset signal R of the F/F circuit 14 is kept at a low level.

The logical operation upon occurrence of reverse insertion in FIG. 3 is as follows. The remote on/off circuit 22 produces the signal having a high level. The power supply voltage VDD is applied to the DUT and rises up. Again, it is assumed here that the set value of the overload detecting circuit 14 is equal to 80% of the predetermined value of the power supply voltage VDD as described above. However, since the DUT is reversely inserted, the power supply voltage VDD can not increase and does not reach the set value (depicted by a broken line). Therefore, the PG signal PG is kept at a high level without being asserted. The timer circuit 11 produces the count-up signal CY of a high level after lapse of the preselected time period of 200 μsec. As a result, the AND circuit 13 produces a high level signal. Thus, the reset signal R of the F/F/ circuit 14 is turned into a high level so that the F/F circuit 14 is reset. When the F/F circuit 14 is reset, the remote on/off circuit 22 turns the output signal into a low level and thereby the DUT power supply 2 stops power supply to the DUT. The PG signal PG is kept at a high level and each of the count-up signal CY and the reset signal R to the F/F circuit 14 is turned into a low level.

In the power supply system according to the first embodiment, it is possible to detect, as the reverse insertion of the DUT, the overload immediately after the DUT power supply 2 is turned on and to shut down power supply to the DUT in a short time approximately equal to a rise time of voltage in the DUT power supply 2. The DUT power supply 2 asserts the PG signal PG when the power supply voltage VDD reaches a value equal to or greater than the set value. Normally, a rise time of about several hundred μsec is required after the DUT power supply 2 is turned on and before the PG signal PG is asserted. In case where the DUT is reversely inserted, short-circuiting between the power supply voltage VDD and GND occurs inside the DUT. Therefore, due to voltage drop caused by overcurrent, the output voltage is continuously kept below the set value. Thus, if the PG signal PG is not asserted for a time period longer than the normal power supply rise time (several hundred μsec) after the DUT power supply 2 is turned on, occurrence of reverse insertion can be detected.

In this connection, the judging circuit 1 contains the timer 11 and masks the PG signal PG from the DUT power supply 2 for a time period until the output voltage of the DUT power supply 2 reaches the set value or more. After lapse of a count-up time by the timer 11, the PG signal PG is unmasked. If the PG signal PG is in a negated state at this time instant, the judging circuit 1 judges occurrence of reverse insertion and shuts down the output voltage of the DUT power supply 2. When the DUT is reversely inserted, it is possible to shut down the power supply in a short time approximately equal to the rise time of the power supply voltage in the DUT power supply 2. Therefore, the DUT is power-supplied only for a short time upon occurrence of the reverse insertion so that a breakage of the DUT and a damage of the device testing apparatus are not caused. Upon occurrence of the overload caused during the operation of the DUT power supply 2, the DUT power supply 2 is instantaneously shut down as normal.

Herein, the preselected time period of the timer circuit 11 is determined on the assumption that a plurality of DUTs are inserted in all of the DUT sockets 3. In this case, about 100 μsec is required after the DUT power supply 2 is turned on and before the PG signal PG is asserted. Therefore, the timer 11 is set so that the timer 11 is timed up after lapse of 200 sec and the value or level of the PG signal PG at that time instant is judged. Thus, as seen from the DUT power supply 2, the load of the DUT sockets 3 is heaviest. However, taking into account that the load varies depending upon the number of DUTs inserted into the DUT sockets 3, the count-up time of the timer 11 can be further reduced so that the time of power supply to the DUT upon occurrence of the reverse insertion can further be shortened. Thus, it will readily be understood that the count-up time of the timer circuit 11 can be set as desired. Similarly, the set value of the overload detecting circuit 21 is equal to 80% of the predetermined value of the power supply voltage VDD in the foregoing description but may be changed as desired.

The power supply system according to the first embodiment comprises the judging circuit 1, the overload detecting circuit 21, and the remote on/off circuit 22. When the judging circuit 1 detects overload immediately after the DUT power supply 2 is turned on, the power supply is automatically shut down. Originally, an overload detecting mechanism of a power supply apparatus mainly serves to detect overload caused during operation of the power supply apparatus. However, by combining the judging circuit 1 according to this invention, it is possible to achieve the power supply system having a high-speed reverse insertion detecting mechanism in the device testing apparatus.

### Second Embodiment

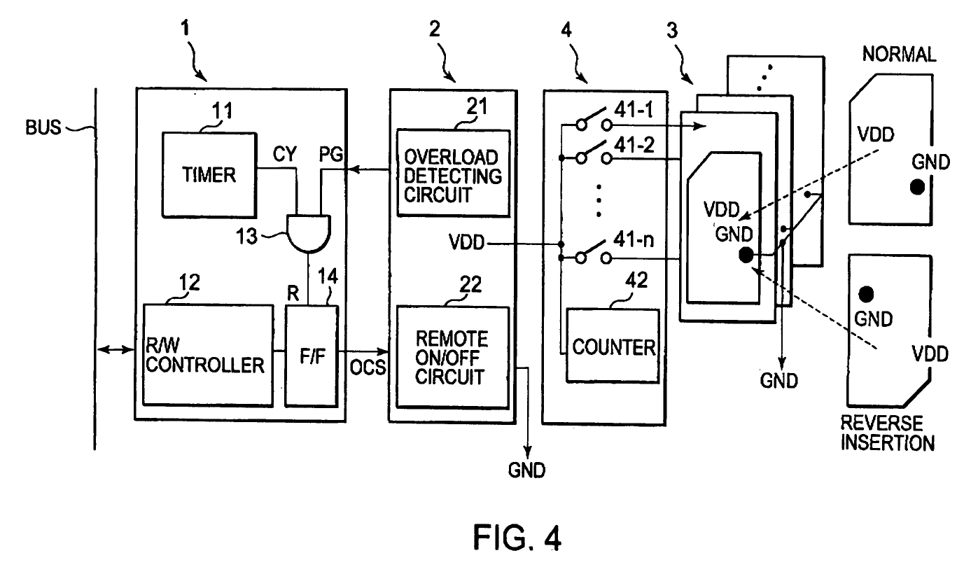

Referring to FIG. 4, a power supply system according to a second embodiment will be described. The power supply system according to the second embodiment further comprises a counter switch 4 connected between the DUT power supply 2 and the DUT sockets 3 in addition to the structure of the first embodiment illustrated in FIG. 1. The counter switch 4 is adapted to switch connection between the DUT power supply 2 and the DUT sockets 3 so as to supply power from the DUT power supply 2 to the DUTs one by one. Thus, by the counter switch 4, it is possible to detect the overload for each individual DUT. Similar parts similar to those of the first embodiment are designated by like reference numerals and description thereof is omitted.

The counter switch 4 comprises a plurality of switches 41-1 to 41-n and a counter 42. The counter 42 counts up by one and sequentially selects the switches 41-1 to 41-n so as to judge overload detection for the respective DUT sockets 3. Each individual overload detecting mechanism is similar to that of the first embodiment. By sequentially switching the overload detecting mechanisms by the counter switch 4, the DUT sockets 3 are automatically and continuously judged.

The DUT power supply 2 is turned on through the system bus BUS. Subsequently, for the DUT sockets 3 connected to the counter switch 4, the states of the power supply are sequentially read with respect to all of the DUT sockets 3. As a result, if the DUT power supply 2 is in an on state, it is judged that the DUT is normally inserted. If the DUT power supply 2 is shut down, it is judged that the reverse insertion of the DUT occurs. Since the counter 42 judges a sequential order of the sockets 3, it is possible to easily obtain information of which DUT is reversely inserted.

In the second embodiment, the counter switch 4 is added to the first embodiment. The counter switch 4 automatically switches connection to the respective DUT sockets 3. With this structure, each DUT socket is subjected to overload detection and the power supply is shut down upon occurrence of reverse insertion. As a result, the power supply system is capable of individually detecting overload for each of the DUT sockets.

Although this invention has been described in conjunction with two preferred embodiments thereof, it will readily be understood that this invention is not restricted to the foregoing embodiments but may be modified in various other manners within the scope of this invention.

What is claimed is:

1. A power supply method in which, when a power supply voltage is applied to a device under test, the power supply voltage is continuously monitored from a rise time instant of the power supply voltage at the start of application of the power supply voltage.

2. The power supply method according to claim 1, wherein application of the power supply voltage is shut down if the power supply voltage does not reach a set value in a preselected time period from the start of application of the power supply voltage.

3. A power supply system comprising:
a power supply for applying a power supply voltage to at least one device under test;
a timer for counting up a preselected time period from the start of application of the power supply voltage; and
an overload detecting circuit for detecting whether or not the power supply voltage applied to the device under test is equal to or higher than a set value;
application of the power supply voltage being shut down if the overload detecting circuit detects, after lapse of the preselected time period, that the power supply voltage applied to the device under test is lower than the set value.

4. The power supply system according to claim 3, further comprising a logical circuit and a remote on/off circuit, the logical circuit executing a logical operation between an output of the overload detecting circuit and an output of the timer to produce a logical operation result as an output control signal, the remote on/off circuit controlling application of the power supply voltage in response to the output control signal.

5. The power supply system according to claim 3, wherein the power supply system is adapted to apply a power supply voltage to a plurality of devices under test, the power supply system further comprising a counter switch between the devices under test and the power supply, the counter switch being for sequentially switching connection between the devices under test and the power supply.

6. The power supply system according to claim 4, wherein the power supply system is adapted to apply a power supply voltage to a plurality of devices under test, the power supply system further comprising a counter switch between the devices under test and the power supply, the counter switch being for sequentially switching connection between the devices under test and the power supply.

7. A device testing apparatus having a power supply system, the power supply system comprising:
a socket for receiving a device under test to be inserted therein;
a power supply for applying a power supply voltage to the device under test; and
a judging circuit for judging whether or not the power supply voltage applied to the device under test is equal to or higher than a set value;
the judging circuit stopping application of the power supply voltage to the device under test if the power supply voltage applied to the device under test is lower than the set value.

8. The device testing apparatus according to claim 7, wherein the judging circuit comprises a timer for counting a preselected time period from the start of application of the power supply voltage to the device under test, the judging circuit judging that the device under test is reversely inserted into the socket to stop application of the power supply voltage to the device under test if the power supply voltage applied to the device under test does not reach the set value within the preselected time period.

9. The device testing apparatus according to claim 7, wherein the power supply comprises a remote on/off circuit for controlling application of the power supply voltage to the device under test, the remote on/off circuit stopping application of the power supply voltage to the device under test in response to an output control signal from the judging circuit.

10. The device testing apparatus according to claim 8, wherein the power supply comprises a remote on/off circuit for controlling application of the power supply voltage to the device under test, the remote on/off circuit stopping application of the power supply voltage to the device under test in response to an output control signal from the judging circuit.

11. The device testing apparatus according to claim 7, wherein the power supply system comprises a plurality of sockets and further comprises a counter switch between the sockets and the power supply, the counter switch sequentially switching connection between the sockets and the power supply.

12. The device testing apparatus according to claim 8, wherein the power supply system comprises a plurality of sockets and further comprises a counter switch between the sockets and the power supply, the counter switch sequentially switching connection between the sockets and the power supply.

13. The device testing apparatus according to claim 9, wherein the power supply system comprises a plurality of sockets and further comprises a counter switch between the sockets and the power supply, the counter switch sequentially switching connection between the sockets and the power supply.

14. The device testing apparatus according to claim 10, wherein the power supply system comprises a plurality of sockets and further comprises a counter switch between the sockets and the power supply, the counter switch sequentially switching connection between the sockets and the power supply.
